(19) United States
(12) Patent Application Publication
(10) Pub. No.: US 2005/0058970 A1
(43) Pub. Date: Mar. 17, 2005

(54) Behavior modification aide

(76) Inventors: Neil Perlman, Lincolnshire, IL (US); Daniel Mapes-Riordan, Evanston, IL (US)

Correspondence Address: Robert M. Mason;Mason & Petruzzi, 13601 Preston Rd., 402W, Dallas, TX, 75240, US

(21) Appl. No.: 10/787,862

(22) Filed: Feb. 26, 2004

Related U.S. Application Data
(60) Provisional application No. 60/450,108, filed on Feb. 27, 2003.

(51) Int. Cl. G05B 15/00; G09B 19/00

(52) U.S. Cl. 434/127; 600/921

(57) ABSTRACT

A behavior modification aide includes a user-modifiable BMI (body mass index) goal, weight goal, a display for displaying messages dependent upon the daily eating schedule and exercise schedule and the number of times the user-initiated habit-occurrence indicator is used, and an overall visual indication of the degree to which the user is maintaining the eating and exercise schedule

This application is based on provisional application Ser. No. 60/450,108, filed Feb. 27, 2004.

### BACKGROUND OF THE INVENTION

The invention relates generally to the field of habit devices, and more particularly to a behavior modification aide, such as an exercise and diet modification aide.

According to the most recent surgeon general report, 61% of adults in the United States were overweight or obese. Overweight is defined as a Body Mass Index or “BMI” between 25 and 30, while obesity is a BMI greater than 30. This epidemic has entrenched itself in our society to the extent that 13% of children aged 6 to 11 years and 14% of adolescents aged 12 to 19 years were overweight in 1999. This prevalence has nearly tripled for adolescents in the past two decades. The increase in overweight and obesity cuts across genders, age groups, and racial and ethnic groups.

This epidemic of obesity causes 300,000 deaths each year in the United States. Overweight and obesity are associated with heart disease, certain types of cancer, type 2 diabetes, stroke, arthritis, breathing problems, decreased quality of life and depression. The economic cost of obesity in the United States was about $117 billion in 2000.

Overweight and obesity result from an imbalance involving excessive calorie consumption and/or inadequate physical activity. For each individual, body weight is the result of a combination of genetic, metabolic, behavioral, environmental, cultural, and socioeconomic influences. Behavioral and environmental factors are large contributors to overweight and obesity and provide the greatest opportunity for actions and interventions designed for prevention and treatment.

The surgeon general recommends that Americans accumulate at least 30 minutes (adults) or 60 minutes (children) of moderate physical activity most days of the week. More may be needed to prevent weight gain, to lose weight, or to maintain weight loss. Less than ⅓ of adults engage in the recommended amounts of physical activity. Many people live sedentary lives; in fact, 40% of adults in the United States do not participate in any leisure time physical activity. 43% of adolescents watch more than 2 hours of television each day. Physical activity is important in preventing and treating overweight and obesity and is extremely helpful in maintaining weight loss, especially when combined with healthy eating.

### BRIEF SUMMARY OF THE INVENTION

An object of the present invention is to provide reinforcement to help a person modify their diet and increase their exercise.

A related object of the present invention is to provide periodic and on-demand reinforcement to help users eat a healthier diet.

In accordance with a preferred embodiment of the present invention a habit modification aide comprises a user-modifiable BMI (body mass index) goal, weight goal, a display for displaying messages dependent upon a daily eating schedule and exercise schedule and the number of times the user-initiated habit-occurrence indicator is used, and an overall visual indication of the degree to which the user is maintaining the eating and exercise schedule.

In the preferred embodiment the habit is exercise and eating. This habit modification aide of the preferred embodiment of the present invention appears similar to a standard watch but may also be in the form of a key chain fob. Besides having a standard display and side buttons, it has a meal/exercise and information button on the face. The meal/exercise button and the programming inside the watch track exercise and eating habits. The user is simply required to tap the meal/exercise button at the onset of starting each meal and snack or starting or modifying their exercise. They then indicate on the watch which meal or degree of exercise they are participating in. By utilizing positive and negative feedback, the user is encouraged to diminish poor eating habits and increase exercise. The habit modification aide utilizes various displays, messages, sounds, music, and auditory alarms to provide feedback.

Other objects and advantages of the habit modification aide will become apparent from the following descriptions, taken in connection with the accompanying drawings wherein, by way of illustration and example, an embodiment of the present invention is disclosed.

### BRIEF DESCRIPTION OF THE SEVERAL DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow diagram of the Setup procedure of the program of the illustrated embodiment of the present invention.

FIG. 2 is a flow diagram of the embodiment of FIG. 1 illustrating the continued flow of the program.

FIG. 3 is a flow diagram of the programming for the beginning of a new day using the illustrated embodiment.

FIG. 4 is a flow diagram for the initial user set-up.

FIG. 5 is a flow diagram similar to FIG. 4 showing metric measurements.

FIG. 6 is a flow diagram showing user input of exercise information.

FIG. 7 is a flow diagram illustrating an increase in fitness score.

FIG. 8 is a flow diagram showing user input of diet information and the decrease in fitness score.

FIG. 9 is a flow diagram illustrating the use of the information button and display of BMI and other parameters.

FIG. 10 is a flow diagram similar to FIG. 9 showing metric measurements.

FIG. 11 is a flow diagram illustrating the long message generation as used in the preferred embodiment of the present invention.

FIG. 12 is a flow diagram to set the time and date features of the embodiment.

FIG. 13 is a flow diagram illustrating the short message generation as used in the preferred embodiment of the present invention.

FIG. 14 is a flow diagram illustrating how the heart rate calculations are derived.

FIG. 15 is a flow diagram illustrating the chronograph feature of the embodiment.

FIG. 16 is a flow diagram illustrating the alarm-setting feature of the embodiment.

FIG. 17 is a flow diagram illustrating the three medicine alarms of the embodiment.

FIG. 18 is a flow diagram illustrating the timer feature of the embodiment.

FIG. 19 is a perspective view of the watch and face of the behavior modification aide in accordance with a preferred embodiment of the present invention.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

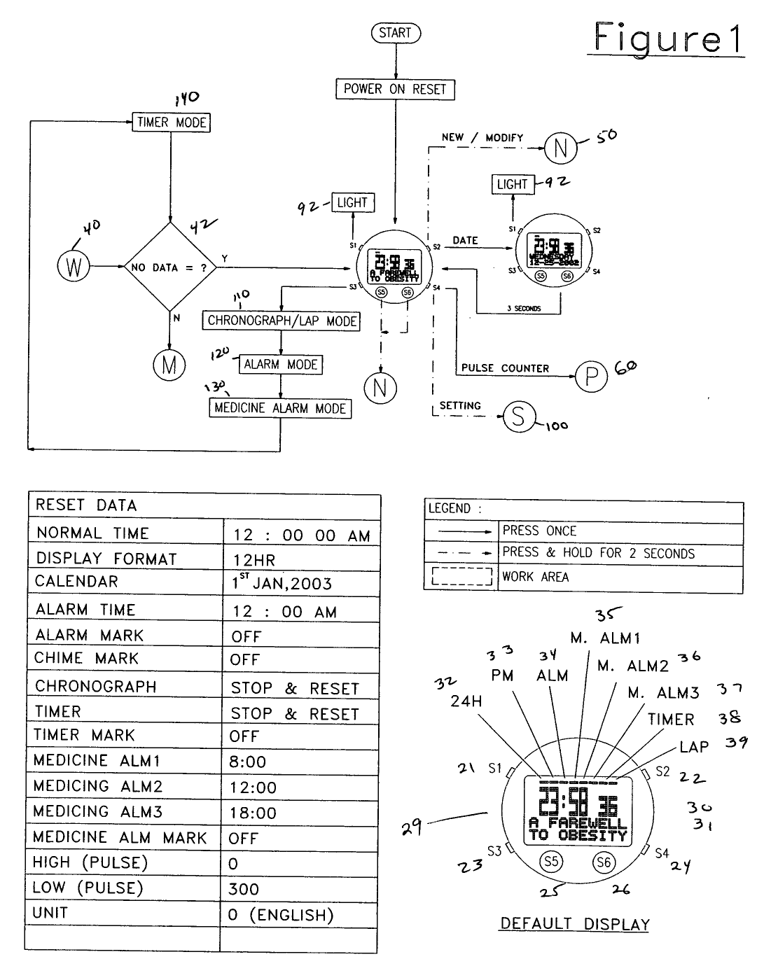

Turning first to FIG. 1, there is shown in more detail the initial set up flow chart of the behavior modification aide in accordance with a preferred embodiment of the present invention. While the invention may take on a variety of outward appearing forms, the illustrated embodiment is a watch as shown in FIGS. 19A, 19B, and 19C and has six button switches S1, S2, S3, and S4 along the outer periphery, and S5 and S6 on the face of the watch, the operation of each will be described in more detail below. The watch may be attached to a watchband or a key chain fob. The display of the illustrated embodiment is a dot matrix display, but may take on any form appropriate. The watch has five lines with ten characters in each line. The time may take three lines of display for increased visibility. While the behavior modification functions of the watch are used, the time will not be displayed. The fit watch will also have normal time, date and stopwatch features readily available in the field.

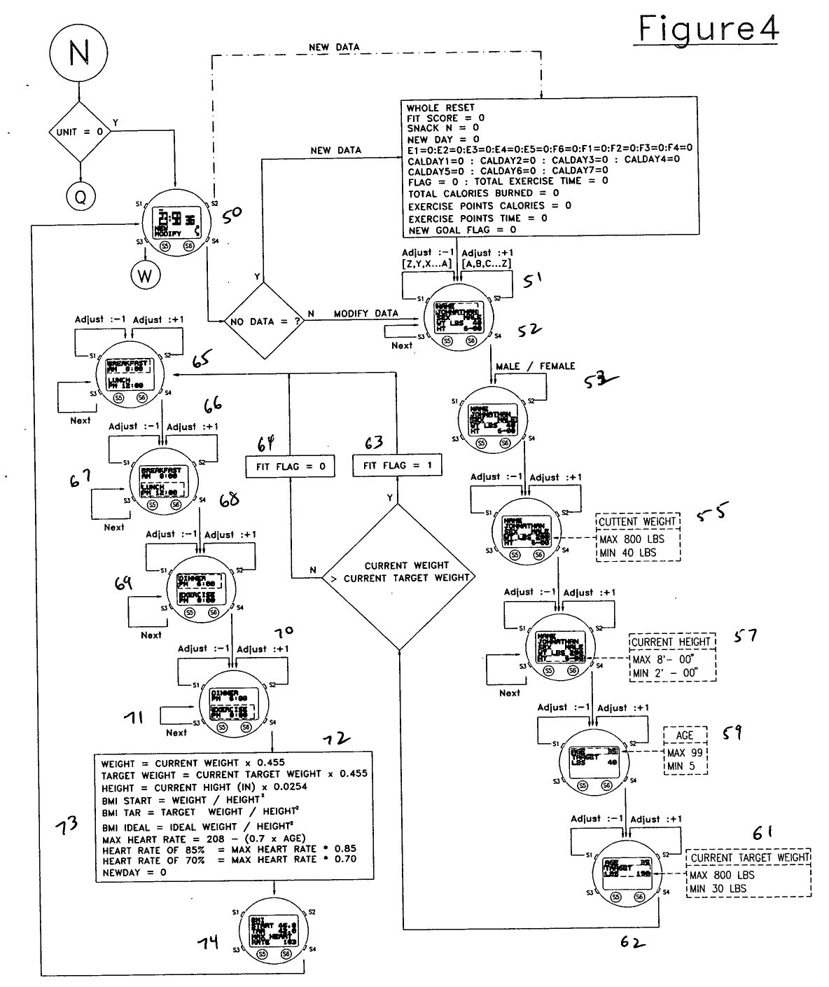

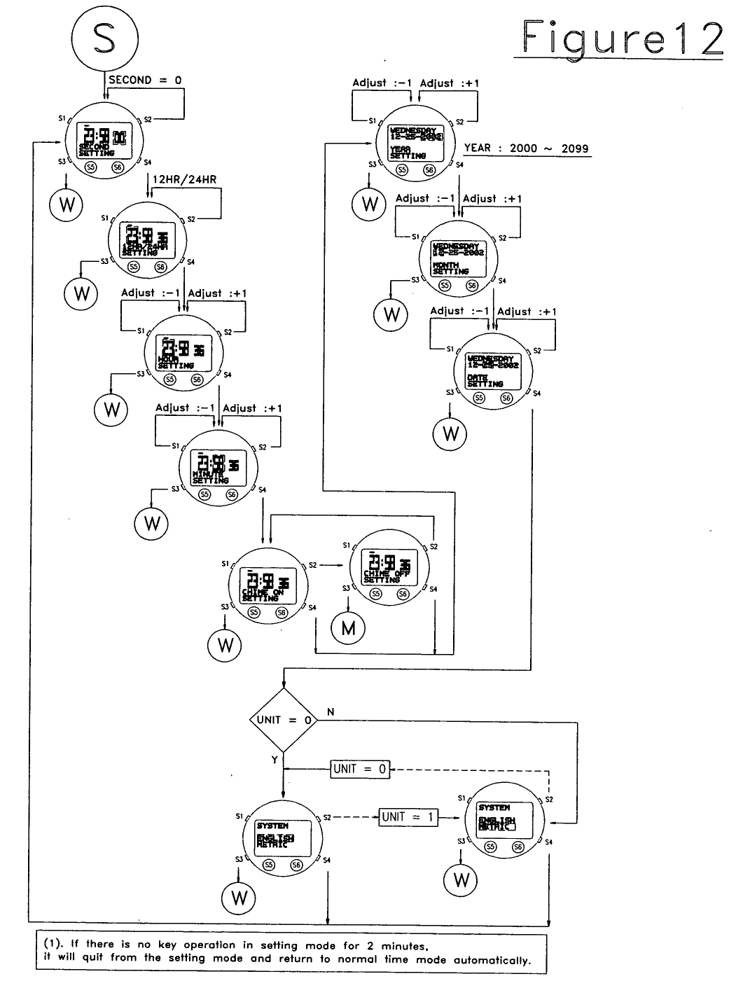

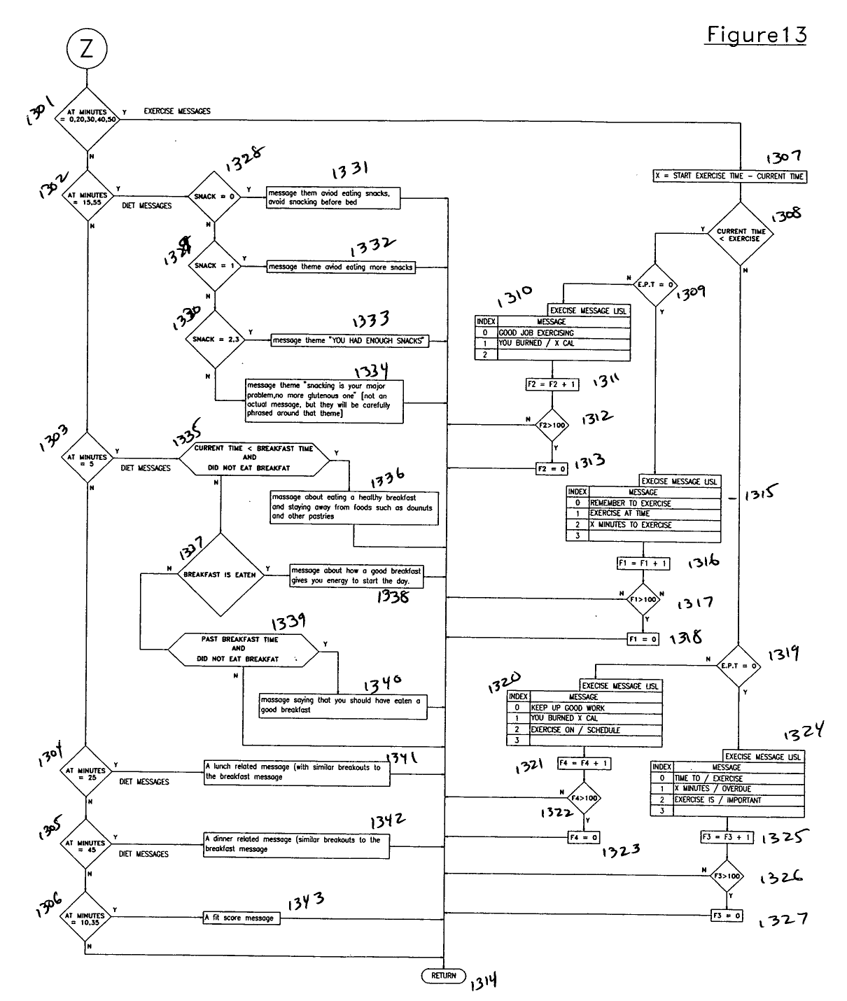

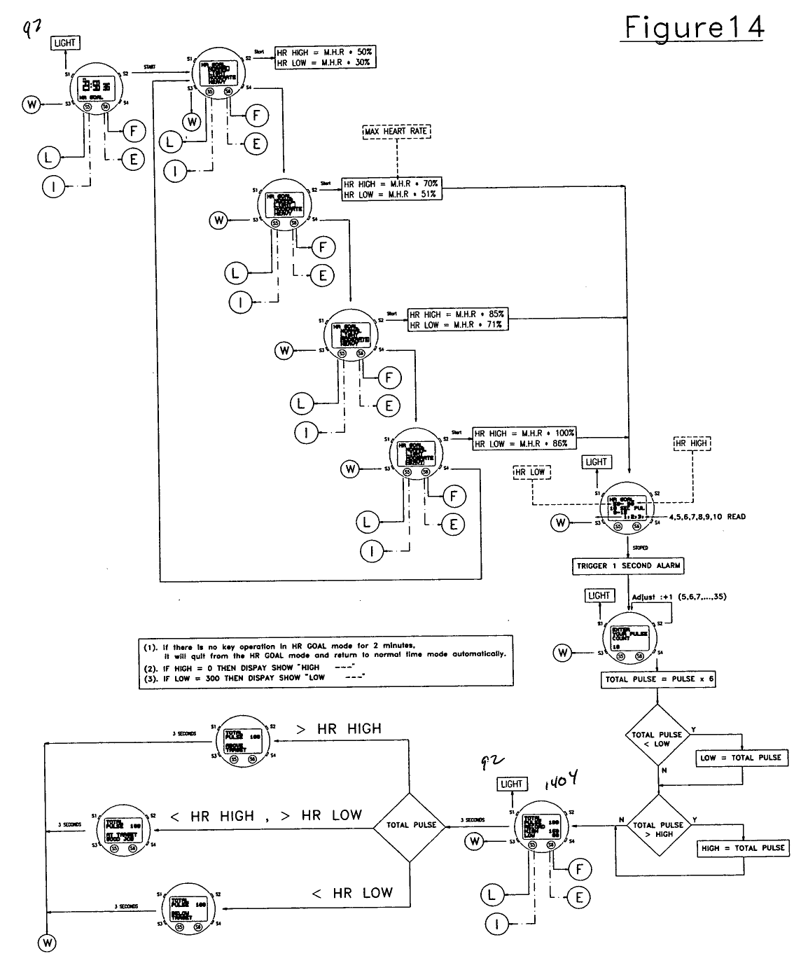

Continuing attention to FIG. 1, each button switch may be depressed once, represented by a solid line, or may be depressed and held depressed for approximately two seconds, represented by a dashed line, though the time may be set by computer program. Upon depression, S1 activates a light to illuminate the display. Depressing S2 once will cause the program to display the current date for approximately three seconds before returning to the initial display. Depressing and holding S2 will allow the user to set their user profile parameters of the program for behavior modification as set out in connection with FIG. 4 below. Successive depressing S3 will cycle the aide though the Chronograph/Lap mode (FIG. 15), Alarm mode (FIG. 16), Medicine alarm mode (FIG. 17), and Timer Mode (FIG. 18), each of which will be explained in more detail below, though have similar features and operation as watches and timers common in the field. Depressing S4 will run the pulse counter routine as described in more detail below in connection with FIG. 14. Depressing and holding S4 will run the time setup mode (FIG. 12)

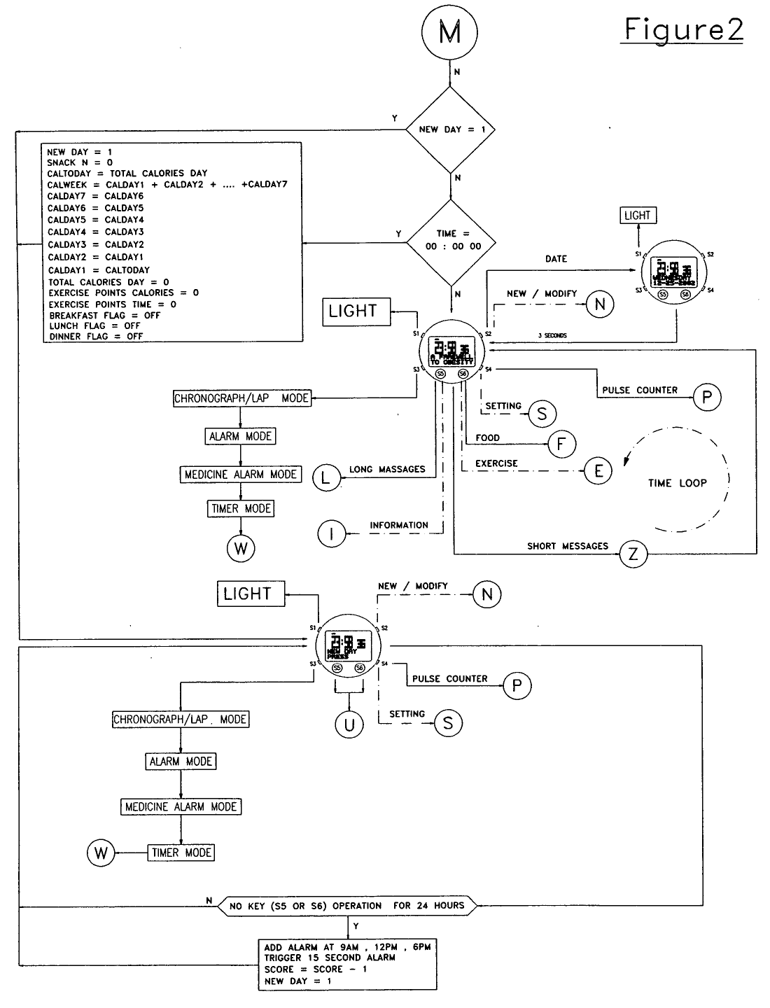

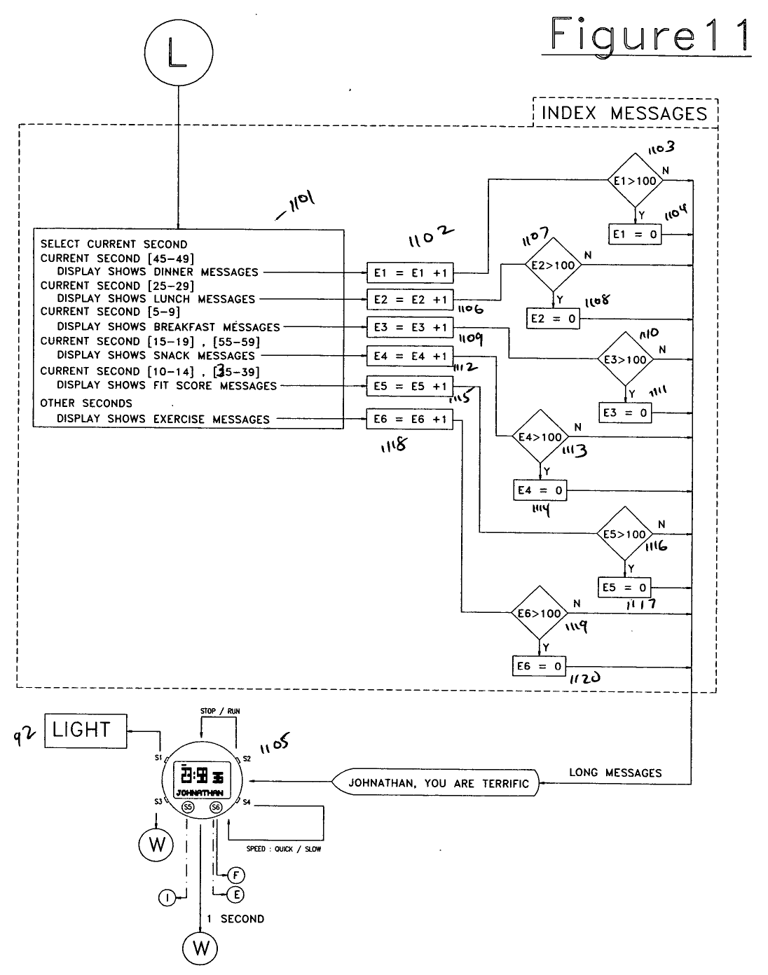

Turning now to FIG. 2, there is shown the flow diagram of the flow of the program. Depressing S5 or the ‘Information’ button, will display long messages in accordance with FIG. 11, while a depressing and hold will display detailed information about BMI, weight, BMI and weight goals, and calories burned last week. Depressing S6 or the ‘diet/exercise’ button, the user can input time of meals eaten and type of exercise being done. If watch is not used for over a day it will sound a beep 3 times a day.

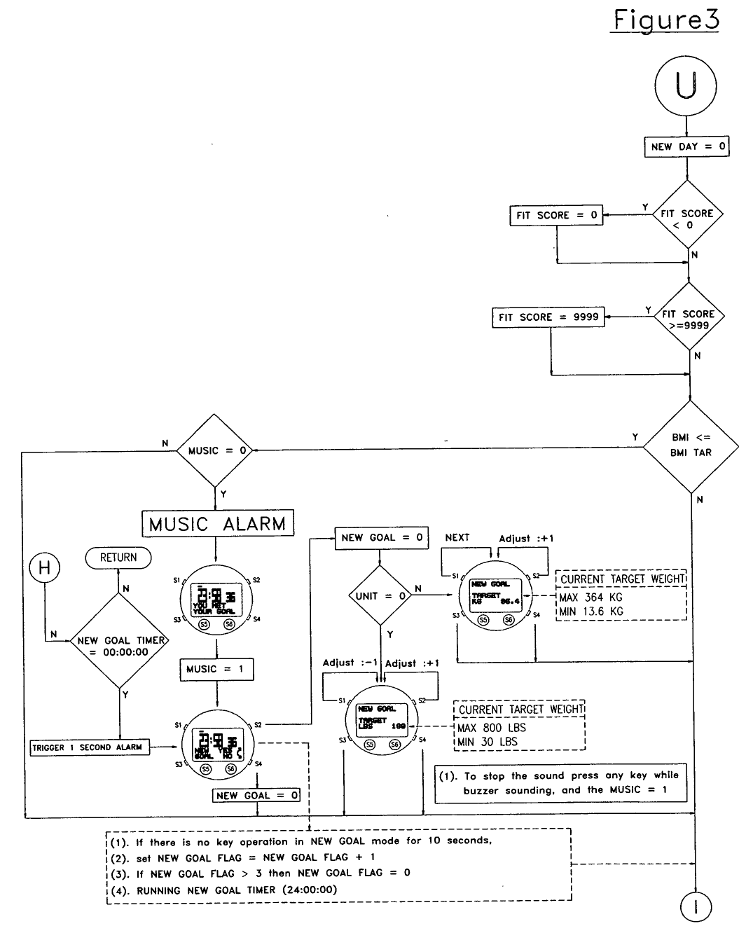

FIG. 3 illustrates the programming for a new day, where the beginning of the day message is displayed based on current scores and weights verses targets. A music alarm may play if targets are reached and weight may be readjusted at this time

FIG. 4 is the program flow chart for the setup mode in US measurements of pounds and feet. The input is predicted time to eat breakfast, lunch, and dinner, and to exercise, as well as the user's gender, height, name, weight, age, and target weight.

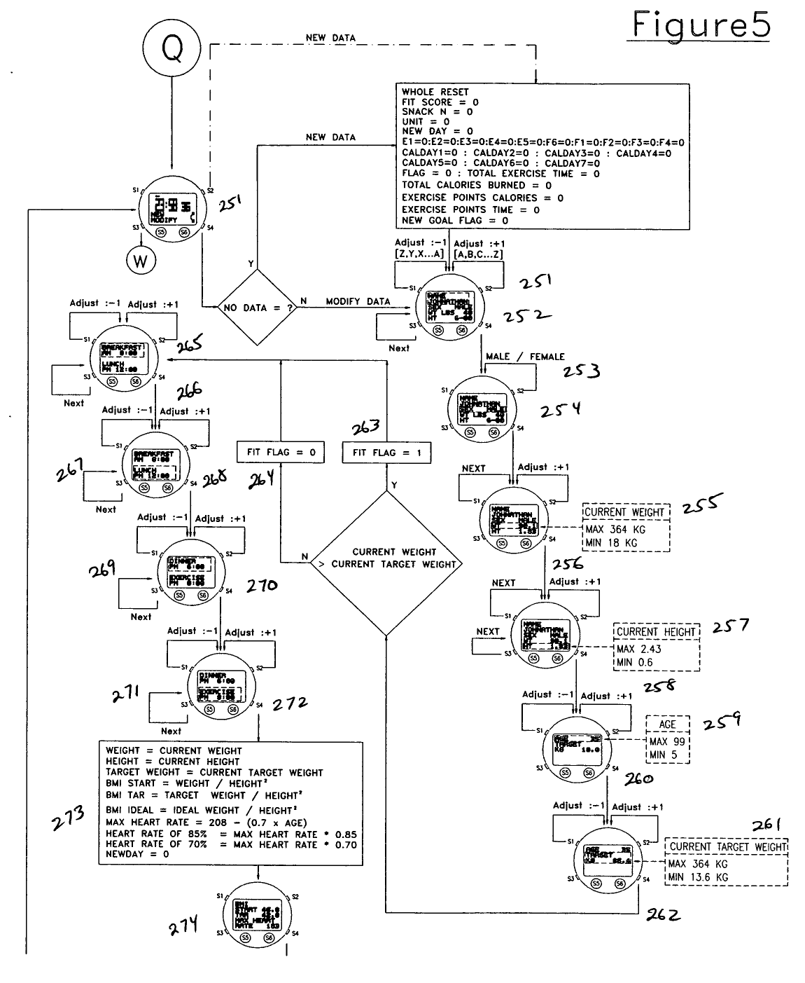

FIG. 5 similar to FIG. 4, though using metric measurements.

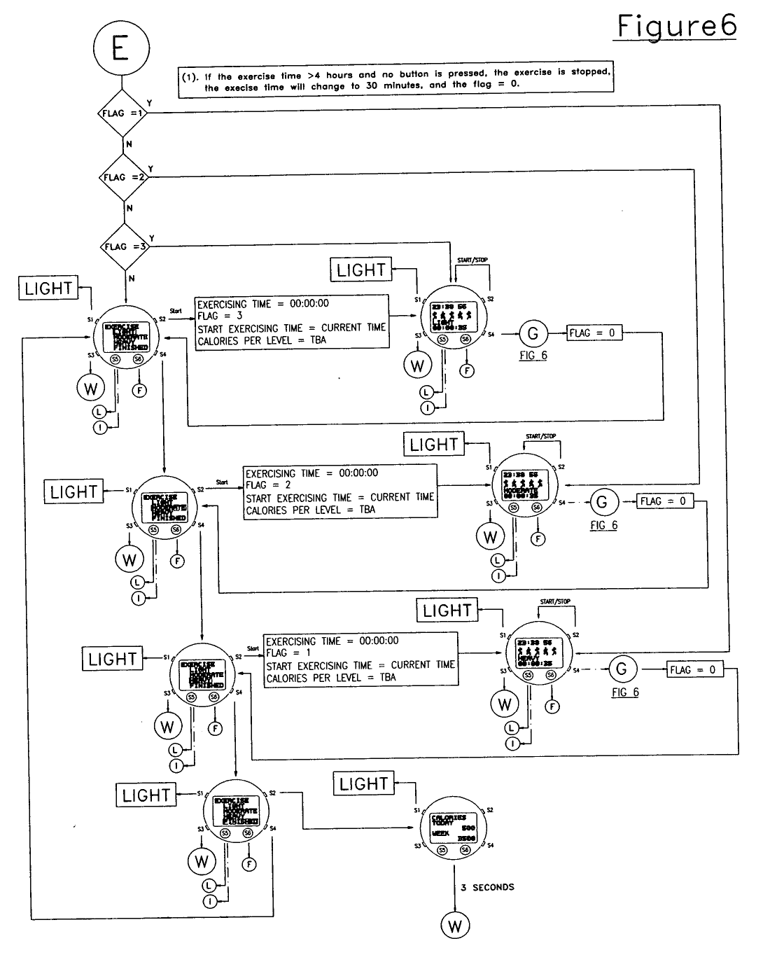

FIG. 6 illustrates the exercise section where the user can input the exercise level and duration. For the illustrated embodiment, exercise is divided into light, moderate, and heavy stages. The user notifies the watch at the beginning and end of each type of exercise. Different calories are used based on a height, weight, and time formula, see below for calorie calculations. The calories are totaled for each section of exercise for the day and for the week. There can be animation of a running guy scrolling across the screen during exercise, as it is entertaining and notifies the user that it is in exercise mode and not normal time mode. The time is displayed on the very top row, though much smaller, while the active exercise time is displayed on the bottom row.

Depressing the exercise/meal button will allow the user to change out of each mode. There can also be a user guide about what is light, moderate and heavy exercise included with the watch though it will largely be left tot the user to determine, based on the totality of the circumstance of the user and the level of exercise. If the user does not exit out after 4 hours, the watch will leave exercise mode and go back to regular mode.

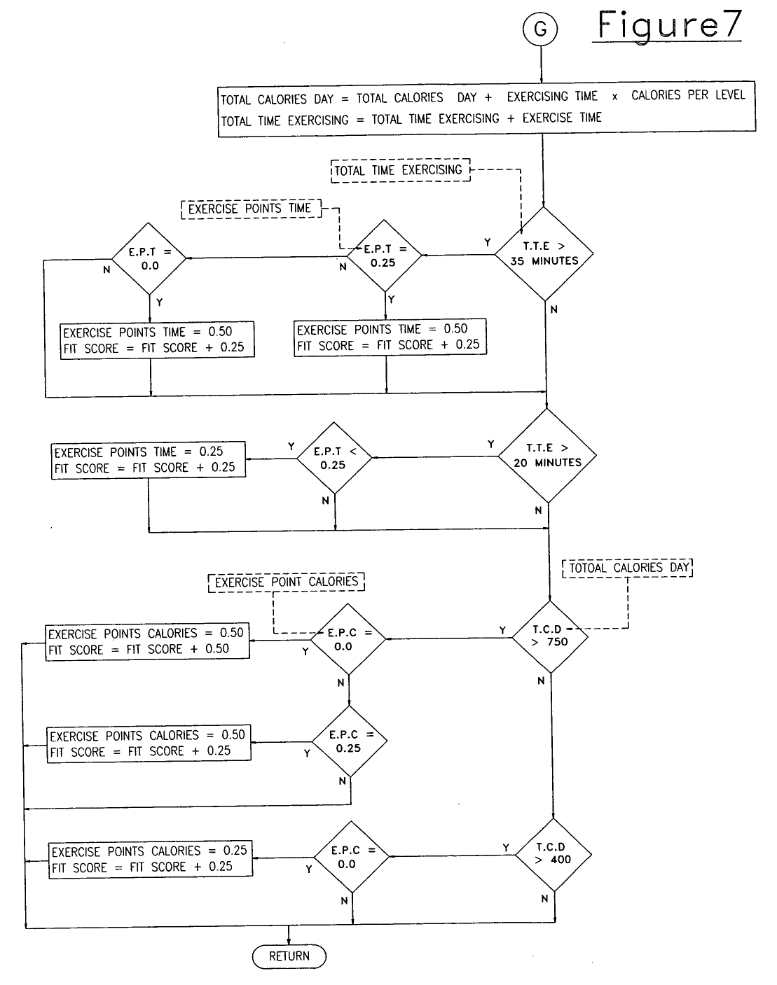

FIG. 7 illustrates the increase of the ‘fit score’. The fit score starts at 0 and will slowly increase if the user exercises, up to 1 point a day. This is automatic once certain levels are achieved based on time and calories.

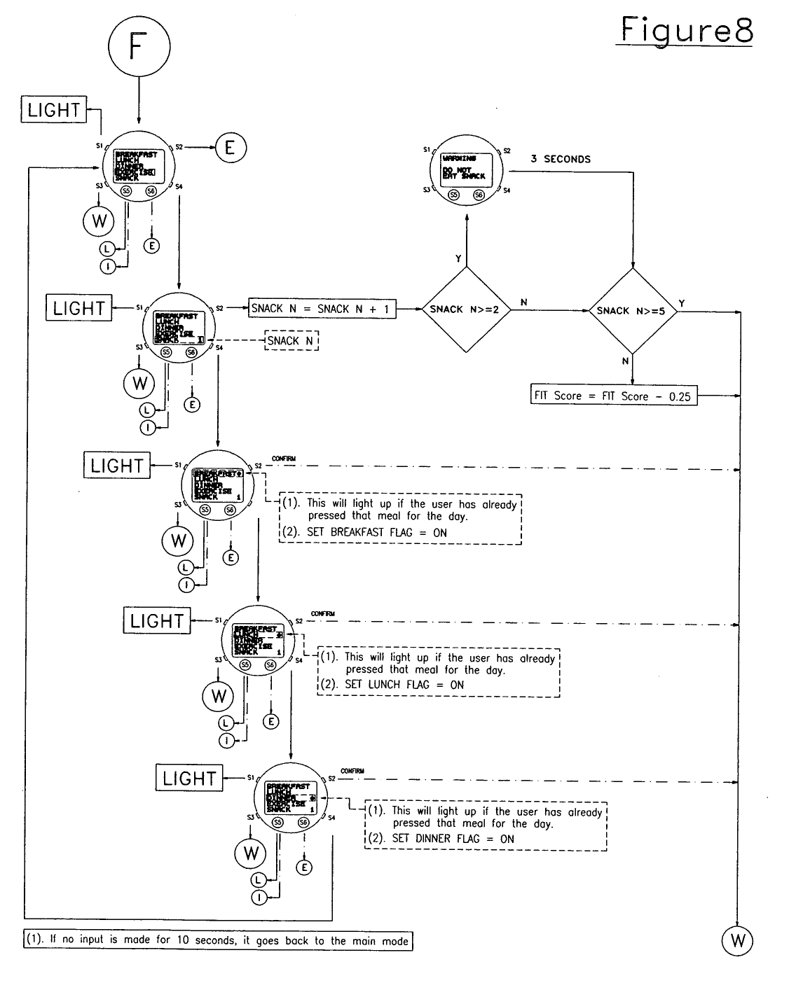

FIG. 8 illustrates how the fit score can decrease, though not below zero. It is in the preferred embodiment solely based on how many snacks per day the user has. The illustrated embodiment can lose up to 1 point a day if 4 snacks in that day are consumed. The watch will also display a lit diamond to show what meals have been eaten for the day.

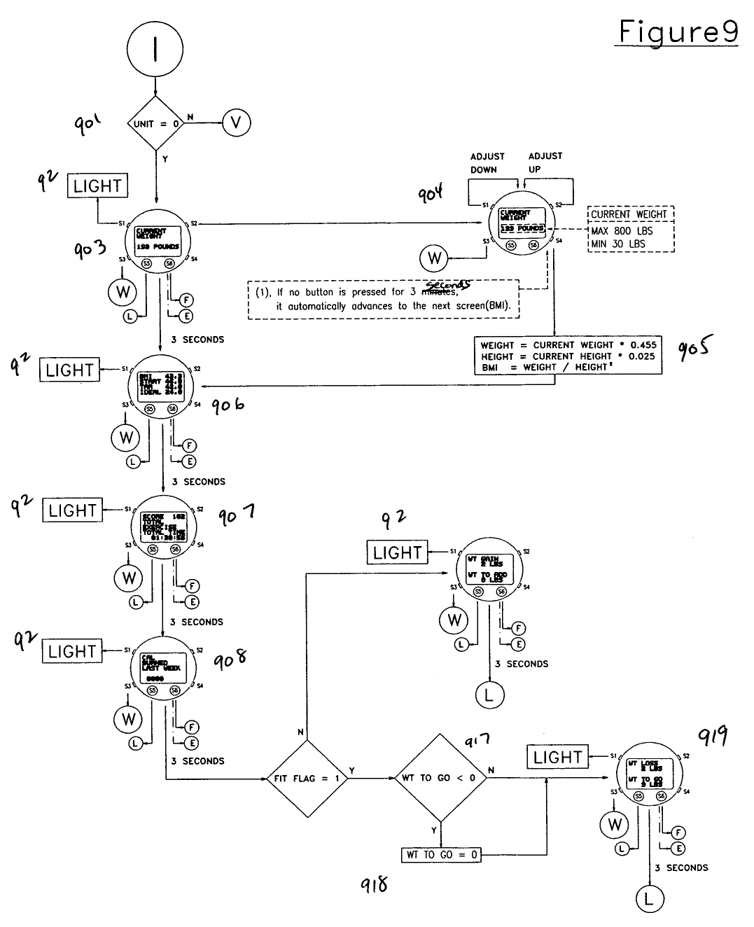

FIG. 9 illustrates the information displayed when user depresses the ‘INFO’ button. The watch will show for a depression and hold of the information button the following: Current weight, BMI current, BMI start, BMI target, BMI ideal, SCORE, Total exercise time day, Cal burned last week, Weight loss (or gain) and weight to go for goal.

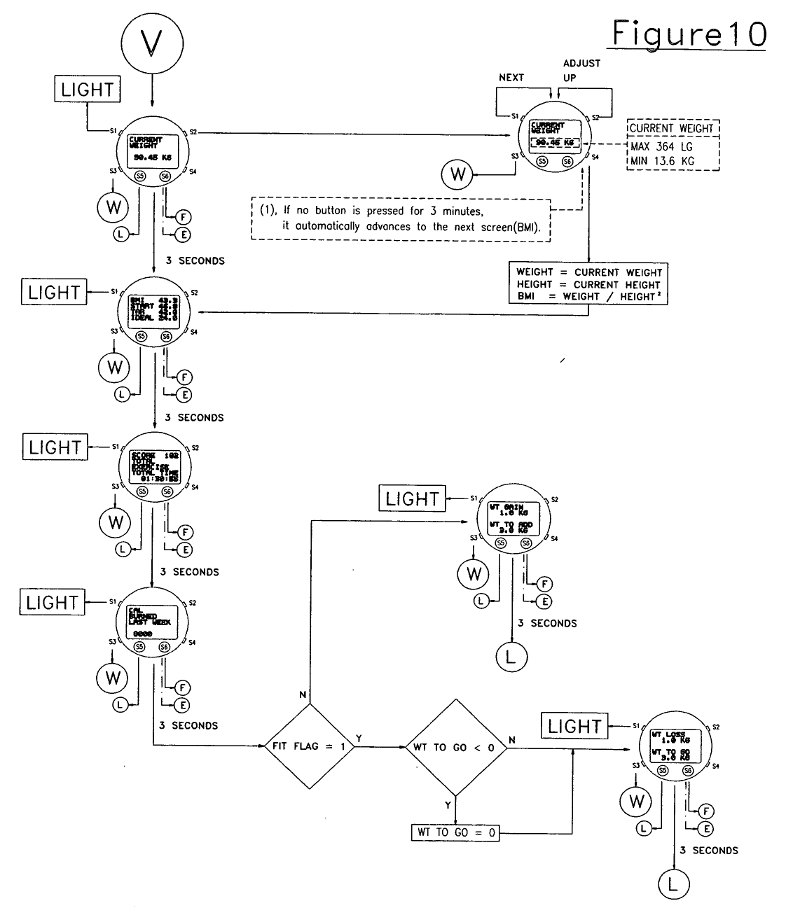

FIG. 10 is similar to FIG. 9, though in metric measurements.

FIG. 11 is the flow diagram illustrating the long message generation and display message. Any appropriate message may be displayed as described in the categories. Based on the seconds displayed when the button is pressed, similar to a random number generator, the watch will show messages based on meals, exercise or fit score. The meal messages will be based on dinner, lunch, breakfast, or snacks.

FIG. 12 shows the time and date setup mode as is similar to other watches in the field. It also sets up either the English or metric system.

FIG. 13 is the flow diagram illustrating the Short message generation and display. The short messages change every 5 minutes and are preset for exercise type messages at 0, 20, 30, 40 and 50 minutes passed the hour. Snack messages will be displayed at 15 and 55; Breakfast messages at 5 minutes passed the hour; Lunch messages at 25 minutes; Dinner messages at 45 minutes: Fit score message at 10 and 35.

The meal messages will change based on the current time verses the time the meal should be eaten and if the meal has been eaten. If breakfast was skipped, a different set of messages will be used then if the person ate breakfast and another group if the time for breakfast has not occurred yet. The invention operates similarly for lunch and dinner. The snack messages are based on the number used that day. Exercise messages are based on if the exercise time has passed or not, and if the person has exercised or not. For example, a reminder message may be displayed if the time has not occurred yet and a congratulatory message may displayed if the person exercised on time.

FIG. 14 shows the heart rate calculation program flow of the illustrated embodiment. It is based on a age and ideal exercise range of 70-85% of max heart rate. It is then broken down to a 10 second pulse count.

For calorie calculations the following is used: light activity 400 calories per hour; Moderate activity 600 calories per hour; and Heavy activity 800 calories per hour Alternately, one can use the MET formula (1 MET is the level of energy you use at rest, 10 METS is ten times the amount of energy you use at rest). As an example, 6 mets as light exercise at 3.2 Kcal per KG per min; 10 METS for moderate exercise at 6.0 kcal/kg/min; and 14 METS for heavy exercise at 8.8 kcal/kg/min. For a 70 KG person the light exercise is 224 kcal per hour, moderate 420 kcal per hour, and heavy 714 kcal per hour. For a 90 kg person light exercise=287 per hour, moderate 540 kcal per hour and heavy 918 kcal per hour.

The pulse counter will be based upon the user age and will display the 70% to 85% range for ideal cardiovascular workout. In the pulse mode it will show:
MAX HR=NNN
85% HR=NNN
70% HR=NNN
PULSE=
NN-NN

The Max HR would be calculated based on age, the 70% and 85% would be based on that calculation. Maximum heart rate=208-(0.7× age). The pulse range would be a 10 second count or the 85% and 70% number divided by 6. The screen would show a ten second countdown using the top three lines.
10
PULSE=
23-28
9
PULSE=
23-28
8
PULSE=
23-28
7
PULSE=
23-28
6
PULSE=
23-28
5
PULSE=
23-28
4
PULSE=
23-28
3
PULSE=
23-28
2
PULSE=
23-28
1
PULSE=
23-28
0
PULSE=
23-28

It will then show:
MAX HR=33
70% max 23
85% max 28

This will be displayed for 3 seconds or until S4 is pressed again and then normal watch mode will resume. If the user presses S4 during the countdown, the countdown will stop and normal watch mode will resume. The purpose of this mode is for the user to see what their target heart rate for exercise is and give them a quick pulse counter. They can exit it quickly by hitting S4 twice if they did not want to use the pulse counter.

The present invention will keep track of when people eat breakfast, lunch, dinner and snacks and how often, how long, and with what intensity they exercise. In the initial setup mode, the users will be asked when they eat each meal and when they plan on exercising. The messages will be based upon if they eat their meal at the correct time, if they are snacking and if they are exercising. Throughout the day the person will be receiving messages based on breakfast, lunch, dinner, snacking, and exercising. The breakfast messages will recommend to eat a well balanced breakfast but if they did not eat breakfast and it has passed the time they were supposed to eat breakfast, the message may be related to why the should not skip breakfast. A similar type of message will be displayed for lunch and dinner. The snack messages will encourage the user not to snack. If they have snacked, it would encourage them not to have another snack. If they have had too many snacks the messages will be then based upon trying to limit the number of snacks they will eat in the future. The fitness score at will go down if they eat snacks up to a maximum of 1 point per day. The fitness score can also increase up to one point per day if they exercise. The fitness score increase is based upon level of exercise, time of exercise and estimated calories expanded per day.

FIG. 1 is a flow diagram of the main loop of the program of the illustrated embodiment of the present invention.

FIG. 2 references the actions taken after a particular button is pressed for a brief or extended period of time.

FIG. 3 is a flow diagram demonstrating calculations that are made based upon the prior day's actions. It describes calculation of the fit score, and messaging displayed based on that fit score. It also describes how the current weight or a new target weight can be set.

FIG. 4 is a flow diagram demonstrating the initial setup mode. In this demonstration, the user enters then the preferred time for breakfast, lunch, dinner, and the daily exercise period. The user also enters then their sex, height, weight, and age, along with their target weight.

FIG. 5 is a flow loop diagram, allowing the user to modify the times they eat breakfast, lunch, dinner and when they exercise. It also allows the user to reset the demographic information of age, sex, weight, height and target weight.

FIG. 6 is a flow diagram, demonstrating how the exercise time is entered into the program, rating the exercise as light, moderate, heavy. It also describes the actions taken when exercise has finished. This also describes the animation showing on the display while the person is exercising. While exercising the watch also displays the current time and the time of exercise.

FIG. 7 is a flow diagram demonstrating the calculation of the calories expended and the modification to the fit score based upon the exercise duration and intensity.

FIG. 8 is a flow diagram and allowing the user to input the times they eat different meals or snacks. This also describes a calculation to the fit score based upon the meals.

FIG. 9 is a flow diagram showing the different informative displays that the watch provides either at the beginning of a day or upon instructions by the user. The watch will display the current weight in pounds, the current BMI, along with the BMI they started with, the target goal, and the ideal body weight based upon their height. It will also show the fitness score, the total time of exercise, along with the calories expended in the past week. Also displayed is the difference in somebody weight since the last goal was sets and the amount of weight in pounds needed to be lost or gained needed to reach their goal. It also allows the user to enter in a new weight.

FIG. 10 is a flow diagram identical to figure nine except the units for weight and height are in the metric system instead of the English system.

FIG. 11 is a flow diagram describing the calculations needed to display the different long messages. The messages rotate based upon a random number generator. In this embodiment of the random number generator is based upon the seconds currently displayed on the watch. The messages displayed are designed to aid the user in adjusting their habit. In this embodiment, the messages are based upon breakfast, lunch, dinner, snacking, exercising, or previously stored statistics such as the fit score.

FIG. 12 is a flow diagram allowing the user to set the time, date, and other settings for the watch. It also allows the user to change from English to the metric system.

FIG. 13 is a flow diagram showing abbreviated or short messages that rotate every five minutes. These messages are based upon exercising, dieting based on breakfast, lunch, dinner, and snacking. The meal related messages will automatically adjust if the user has eaten a meal by the time of day preprogrammed for that meal. The exercise related messages are designed to increase exercise more our based upon recent exercise statistics for the user.

FIG. 14 is a flow diagram showing the target heart rate recommended for exercising based upon their age. It also displays a 10 second pulse counter and what the 10 second pulse count should be for the exercise range of 70% to 85% of predicted maximum heart rate.

The overall messages will change based upon the fitness level that the user has inputted initially. There will be four fitness levels.
1. Beginner
2. Intermediate
3. Advanced.
4. Bariatric surgery.

In beginning mode, the exercise messages will be based upon a beginner. The diet messages will be based upon a person with poor eating habits and the goal would be to make them into mildly improved. In the intermediate category, the exercise level will be more intense and the diet messages will assume the person has a half way decent diet. In the advanced mode, the program will display very aggressive exercise type messaging and then diet messages will also be aggressive. For the Bariatric Surgery mode, the exercise level will be beginner, and the meal related messages will be based upon small frequent high protein meals, which are typical after this type of surgery.

In accordance with the preferred embodiment of the present invention and as shown in FIG. 1, the invention takes the form of a watch 10. Watch 10 can be attached to a wristband for wearing in a similar fashion as other wristwatches, or attached to a solid or flexible chain similar to a key chain fob, or simply as a watch device. Display 29 can show multiple lines of text 31, and may be of the LED, LCD, or other appropriate construction, and is shown with two lines of display in addition to the lines indicating standard watch display functions such as time, day, etc. In the illustrated form, there are six input buttons: four are on the side of the watch 21, 22, 23, and 24, and two on the clock face, having a symbol indicative of a information 25 and having a symbol indicative of food/exercise 26. Normally, the watch may display the time, date, and a fitness message in display 31. The message may change, for example, every 5 minutes. It may display, a supportive message to exercise, a message to eat breakfast message to eat a healthy snack, a message congratulating the user for exercising that day or other messages based on the current weight or exercise habits, a combination thereof, or any other appropriate display. The aide may be programmed so that, for example, every 10 minutes throughout the day, the watch will display different encouraging messages to help decrease the desire to eat ice-cream or to remind the user to exercise at a preprogrammed time. Messages may be customized to be more encouraging with a fast rate of decline of weight or more empathetic if the rate is slow. When exercise has been maintained on a regular basis, for example, the watch may be programmed to display the number of days of exercise and a different congratulatory message about the achievement or the health benefits.

FIG. 1 is the watch initial display mode. This is utilized whenever the watch has been activated for the first time on power up or on a global reset. A Global reset is accomplished by pressing buttons 21, 22, 23, and 24 all at once for 2 seconds. This is designed to give an impactful continuous message to help sell the watch and conserve battery power. While in this mode, the button 21 can be pressed to activate the background light for a set period of time. Button 22 can be pressed to show the date on display 31. Holding button 22 for 2 seconds will activate initial set up mode on FIG. 4 for the English system of measurement or FIG. 5 for the metric system. Pressing button 24 for two seconds will allow the user to set the time, date, alarm, and set the watch for English or metric system. Pressing button 23 will activate the chronograph and sequential presses of button 23 will activate the alarm mode, medicine alarm mode or timer mode. Holding buttons 25 or 26 down for 2 seconds will activate initial setup mode (FIGS. 4 and 5)

In operation, the user begins the fitness process by setting the exercise and meal planning schedule and inputting other basic information at the setup process as in FIG. 4 or FIG. 5. The setup information can be entered in the English system (pounds, inches, feet) or the Metric system (kilograms, meters). If the Watch setup mode is in the English system, FIG. 4 will be followed, in the Metric system FIG. 5 will be followed.

Though the particular button(s) may be varied, in the illustrated embodiment, the initial setup mode can be activated by pressing any one of three designated buttons, 22, 25 or 26 and holding them for 2 seconds Upon hitting either of these buttons (22, 26, or 26), the user is lead step-by-step through inputting the required information. Though not necessarily the only information, or the needed information, in the particular embodiment shown, the user during the setup process selects that the user is either establishing a new fitness schedule or modifying a previously entered schedule. The user may select either new or modify by the remaining buttons in any of a variety of well established ways such as toggling between the two options by pressing the buttons. In the illustrated form, the user selects whether the schedule is a new schedule or the modification of a prior schedule by use of buttons 22 and 24. The setup of a new schedule will be explained in detail below, though it will be appreciated that modifying a previously input schedule may be performed in a similar fashion. If the user wishes reset or modify data in the future, only pressing button 22 for at least 2 seconds will allow the user to enter back into setup mode. Holding buttons 25 and 26 will activate other features once the initial setup mode has been exited.

Turning to FIG. 4, upon selecting that the schedule is a new schedule, the user is prompted to input the user's name 51. In the preferred embodiment, a letter will appear on the display 29 and by pressing button 21, the letter will advance or pressing button 22 will retreat by one letter in the order of the alphabet, and may include capital letters, small letters, and symbols. The display will advance to a new letter by pressing button 23 or automatically after a designated time period, such as 5 seconds. To indicate completion of the name input 52, the user may, for example press pulse button 24.

In the preferred embodiment, the user is next prompted to input their sex 53 (male or female). This is adjusted by pressing button 22. When correctly inputted 54, the user presses button 24. The user is next prompted to input the current weight in pounds 55. Button 21 will decrease the weight and button 22 will increase the weight. When completed 56 pressing button 24 will advance to the next step. The user is next prompted to input their height 57. Pressing button 21 will decrease the height and button 24 will increase the height. The height is listed in feet and inches. Pressing button 24 will advance to the next step 58. The user is next prompted to input their age 59. Button 22 will decrease the age and button 24 will increase the age. Pressing button 24 will advance to the next setting 60. The user is next prompted to input the current target weight 61. Pressing button 21 will increase the target weight and pressing button 22 will increase the target weight. The weight listed is in pounds. Pressing button 24 will indicate completion of the target weight setting 62.

In the preferred embodiment, if the current weight is greater then the target weight, the computer program will set its goal and the messages for weight reduction 63. The variable “fit flag” will be set to 1. If the current weight is equal to or less then the goal, the fit flag will be set to zero 64 and no messages encouraging weight reduction will be displayed on the current embodiment. The next step is setting the time the user normally eats breakfast 65. The baseline time is preset for 8:00 am. But may be modified by the user Pressing button 21 will decrease the time and pressing button 22 will increase the time. Pressing button 24 will go to the next step 66; setting the time the user normally eats lunch 67. This time is preset at 12;00 pm, but may be modified by the user. Pressing button 21 will decrease the time and pressing button 22 will increase the time.

In the preferred embodiment pressing button 24 will go to the next step 68; setting the time the user normally eats dinner 69. The time is preset at 6:00 pm, but may be modified by the user Pressing button 21 will decrease the time and pressing button 22 will increase the time.

In the preferred embodiment Pressing button 24 will go to the next step 70; setting the time the user normally exercises 71. The time is preset at 8:00 pm, but may be modified by the user. Pressing button 21 will decrease the time and pressing button 22 will increase the time. Pressing button 24 will go to the next step 72. At this time, programming variables are now defined based on the data recently inputted, defining the variables needed in the calculations and keeping track of the current BMI, Maximum Heart rate based on age, proper exercise heart rate range based upon age with a maximum heart rate of 85% of the predicted maximum heart rate and a minimum heart rate of 70% of the predicted maximum heart rate 73. The BMI (body mass index), target BMI, and Maximum heart rate will then be displayed on 29 74.

Pressing 23 the chronograph button will exit the setup mode 75 and return to normal watch mode 100.

Turning to FIG. 5, upon selecting that the schedule is a new schedule, the user is prompted to input the user's name 251. In the preferred embodiment, a letter will appear on the display 29 and by pressing button 21, the letter will advance or pressing button 22 will retreat by one letter in the order of the alphabet, and may include capital letters, small letters, and symbols. The display will advance to a new letter by pressing button 23 or automatically after a designated time period, such as 5 seconds. To indicate completion of the name input 252, the user may, for example press pulse button 24.

In the preferred embodiment, the user is next prompted to input their sex 253 (male or female). This is adjusted by pressing button 22. When correctly inputted 254, the user presses button 24. The user is next prompted to input the current weight in Kilograms 255. Button 21 will decrease the weight and button 22 will increase the weight. When completed 256 pressing button 24 will advance to the next step. The user is next prompted to input their height 257. Pressing button 21 will decrease the height and button 24 will increase the height. The height is listed in meters. Pressing button 24 will advance to the next step 258. The user is next prompted to input their age in years 259. Pressing button 22 will decrease the age and button 24 will increase the age. Pressing button 24 will advance to the next setting 260. The user is next prompted to input the current target weight in kilograms 261. Pressing button 21 will increase the target weight and pressing button 22 will increase the target weight. The weight listed is in kilograms. Pressing button 24 will indicate completion of the target weight setting 262.

In the preferred embodiment, if the current weight is greater then the target weight, the computer program will set its goal and the messages for weight reduction 263. The variable “fit flag” will be set to 1. If the current weight is equal to or less then the goal, the fit flag will be set to zero 264 and no messages encouraging weight reduction will be displayed on the current embodiment.

In the preferred embodiment the next step is setting the time the user normally eats breakfast 265. The baseline time is preset for 8:00 am. But may be modified by the user pressing button 21 will decrease the time and pressing button 22 will increase the time.

In the preferred embodiment, pressing button 24 will go to the next step 266; setting the time the user normally eats lunch 267. This time is preset at 12;00 pm, but may be modified by the user pressing button 21 will decrease the time and pressing button 22 will increase the time. Pressing button 24 will go to the next step 268; setting the time the user normally eats dinner 269. The time is preset at 6:00 pm, but may be modified by the user Pressing button 21 will decrease the time and pressing button 22 will increase the time. Pressing button 24 will go to the next step 270; setting the time the user normally exercises 271. The time is preset at 8:00 pm, but may be modified by the user. Pressing button 21 will decrease the time and pressing button 22 will increase the time.

In the preferred embodiment pressing button 24 will go to the next step 272. At this time, programming variables are now defined based on the data recently inputted, defining the variables needed in the calculations and keeping track of the current BMI, Maximum Heart rate based on age, proper exercise heart rate range based upon age with a maximum heart rate of 85% of the predicted maximum heart rate and a minimum heart rate of 70% of the predicted maximum heart rate 273. The BMI (body mass index), target BMI, and Maximum heart rate will then be displayed on 29 274.

Pressing 23 the chronograph button will exit the setup mode 275 and return to normal watch mode 100.

In normal watch mode as seen at FIG. 2, while in this mode, the light button 21 can be pressed to activate the background light for a set period of time, button 22 can be pressed to show the date on display 31. Holding button 22 for 2 seconds will activate set up mode to edit a profile or enter in a new user's profile. This is on FIG. 4 for the English system of measurement or FIG. 5 for the metric system. Pressing button 24 for two seconds will allow the user to set the time, date, alarm, and set the watch for English or metric system. Pressing button 23 will activate the chronograph and sequential presses of button 23 will activate the alarm mode, medicine alarm mode or timer mode. The information button 25 will display a long message if pressed for <2 seconds or a series of information short messages if pressed for 2 seconds.

To set the basic functions of the watch, button 24 is pressed and held for 2 seconds. This goes to FIG. 12.

Because the preferred use of the present invention is in connection with improved fitness, and because currently, many people wanting to improve their fitness level are taking medication(s), the time setup feature will then prompt the user if the user wants to activate one of the three medication alarms for the purpose of setting an alarm, auditory or otherwise, as a reminder to the user to take the medication. Displays 35, 36, and 37 may be set to show the word ALM1, ALM2, or ALM3 respectively, when activated.

At the user-set time, if the user sets medication alarm 1 or medication alarm 2, or mediation alarm 3, the medication alarm(s) will go off and a message may be displayed in display 12 such as ‘time to take medication’ or ‘take your medication’.

The Display 38 will be activated with the word “TIMER” when the timer mode is activated.

The display 39 will be activated with the word “LAP” when the chronograph mode is activated and the lap button was pressed.

After each time watch 27 detects the passing of 12:00 midnight, the program will reset the number of times a snack occurred to zero and the flags that breakfast, lunch, dinner was eaten. Also, the exercise time and calories expended per day will be reset to zero. The user must indicate the beginning of a new day by, in the illustrated embodiment, pressing information button 25.

If the user does not press any button for >24 hours, the watch can trigger an alarm to remind the user to use the watch. This alarm can be deactivated in the watch setup mode. The purpose of the alarm is to increase compliance with the watch to increase the encouragement in making the dietary and exercise goals.

FIG. 3 is activated at the beginning of every day. If the FIT score is <0, it is readjusted to be 0. It is important not to discourage the user by having a negative score. If the FIT score is >9,999, it will be reset to 9,999. This is done so the fitness score can always be displayed in the messaging so a maximum of 4 numbers are needed to display the messages. If the BMI goal reached the Target BMI goal, a special victory music will be played. The display will than ask the user if a new goal is desired. If button 22 is pressed, the new target will be displayed in either pounds or kilograms, based on the type of units chosen from the setup mode. The weight displayed can be adjusted upward with button 21 or downward with button 22. Pressing button 23 or 24 would cause the program to return to regular mode as seen on FIG. 2. If a new goal was set, the variables on FIG. 2 will be reset.

Each time the user begins to exercise, the user is to indicate such by pressing exercise button 24 for at least 2 seconds. The programming inside watch 27 will then refer to flow chart 6. The display 29 will then show the phrases
EXERCISE
LIGHT
MEDIUM
HEAVY
FINISHED

By pressing the button 22, the user will then activate “light exercise mode”. The display 29 will show the time of day on the top line, animation of a running man on the second line, the word “light” on the third line, and the duration of time in “light exercise” mode on the fourth or bottom line. Time counters will keep track of the duration of time in this mode. This will continue until a button is pressed or for four hours, whichever is first. If no button was press for 4 hours, the time of exercise will be reset for 30 minutes. This is based on the assumption that the user forgot to turn off the exercise time.

If button 22 is pressed, the time of exercise will be paused until another button is pressed. If button 22 is pressed, the time of exercise will restart from the point it stopped. If button 24 is pressed, the watch will then advance to “MODERATE” mode. This is typical of a normal exercise program where a person would start in a “warm up” mode of light exercise and then advance to a more strenuous exercise period. Prior to going into “MODERATE” mode, the programming will then go to flow chart 7 for the calculation of the total calories expended during this exercise period.

Running totals of total exercise time and total calories expended for the day are maintained. The total calories is calculated based upon the level of exercise, weight and a calculation based upon an expected MET level of 6 for mild exercise, 8.5 METS for moderate exercise and 11 meets for strenuous exercise, for example.

The FITNESS score will be increased by 0.25 if at least 20 minutes of exercise per day is obtained and by 0.5 if 35 minutes is obtained. An additional 0.25 points is added if the total calories expended for the day is greater than 400 and 0.5 points if over 750 calories were expended by exercising. The maximum increase per day is 1 point.

Once button 22 is pressed, the display 29 will display “MODERATE” on the third line and a running total of time in MODERATE mode is then started. This will continue until a button is pressed or for four hours, whichever is first. If no button was press for 4 hours, the time of exercise will be reset for 30 minutes. This is based on the assumption that the user forgot to turn off the exercise time. If button 22 is pressed the time of exercise will be paused until button 22 is pressed again. If button 24 is pressed, the watch will activate FIG. 7 and calculate the total calories, total exercise time for the day and readjust the FITNESS score. The watch will then go to HEAVY exercise mode.

HEAVY exercise mode is similar in function to Moderate or Light exercise mode, except for the calorie calculation and the display of “HEAVY” on line three of the display 29. This will continue until a button is pressed or for four hours, whichever is first. If no button was press for 4 hours, the time of exercise will be reset for 30 minutes. This is based on the assumption that the user forgot to turn off the exercise time.

By pressing button 24 again, the exercise mode will then go to the display “FINISHED”. The display 29 will then show,
CALORIES
TODAY
   ###
WEEK
   ###

This will be displayed for a set period of time, 3 seconds and then the watch will reset to the normal mode as in FIG. 2.

Pressing the exercise/food button 26 for <2 seconds will activate FIG. 8. On the display 29 the following will be displayed:
BREAKFAST
LUNCH
DINNER
SNACK

If this is the first time it was activated for the day, the word, “BREAKFAST” will be flashing. Pressing the button 22 will notify the watch that breakfast was eaten at this time. A symbol will then be activated to the right of the word breakfast. The watch will then return to normal watch mode and return to FIG. 2. The next time the food button 26 is pressed, the display will show Lunch blinking and breakfast mode can not be entered.

If button 22 was not pressed when BREAKFAST was flashing and button 24 was pressed instead, the word LUNCH will then blink. Pressing button 22 will then signal the watch that lunch was eaten at that time. A symbol will then be displayed to the right of the word LUNCH. The watch will return to normal mode as seen on FIG. 2. The next time the food button was pressed, lunch will have a mark next to it and it can not be activated again. Instead, the word “DINNER” will be flashing. If button 22 is pressed a similar effect will occur as stated previously for breakfast and lunch. If button 24 is pressed instead, the word, “SNACK” will be flashing. If the word “SNACK” is flashing and button 22 is pressed, a number will appear next to the work snack. The number will start off at 1 and will progress sequentially by one for every time button 22 is pressed while the word, “SNACK” is flashing.

Since having one or two snacks a day is considered part of a balanced diet, the number will be tabulated and displayed when this screen is displayed. However, if a third snack is consumed in one calendar day, the FIT score will decrease by 0.25. A text message warning about excessive snacking will be displayed on 29 for a set period of time. For example, the message, “WARNING, DO NOT SNACK” may be displayed for 3 seconds. If 4 snacks are consumed, then the FIT score will decrease by another 0.025 points and another warning message will be displayed for a set period of time. If 5 or more snacks are consumed, the fit score will not decrease further but other messages will be displayed.

FIGS. 9 and 10 are flowcharts to display information regarding individual exercise and weight data in pounds and kilograms, respectively. Location “I” in the flowchart in FIG. 9 is reached by a long press of button S2 (22). The first operation in FIG. 9 is to determine whether the unit flag is zero or one 901. When the unit flag is not equal to zero it indicates that metric units are being used and processing is carried out as shown in FIG. 10 “V”. Otherwise if the unit flag is equal to zero, English units are used and the old weight setting is set to equal the current weight setting 902 and this number is displayed 903. Pressing pushbutton S3 (23) anytime during the information display described in FIGS. 9 and 10 causes the watch to leave the information display mode and return to normal watch functions. Pressing pushbutton S2 (22) during display 903 allows the user to adjust the displayed weight to match their current weight using pushbutton S1 (21) to decrement the value and S2 (22) to increment the value as shown in display 904. After the user has completed changing the weight setting, pressing the S4 pushbutton (24) causes the watch to recalculate the weight, height, and BMI variables 905 and then displays 906 the current BMI value, the starting BMI value, the target BMI value, and the ideal BMI value based on standard BMI tables. Note that this display 906 can be reached from the initial information display 903 if no button is pressed for three seconds. Similarly, display 907 is shown three seconds after display 906 if no button is pressed. Display 907 shows the current fit score and the total exercise time. After three seconds of display 907, display 908 is shown indicating how many calories were burned in the past week. After three seconds of display 908, temporary variables D equal to the current target weight minus the current weight, and D1 equal to the old weight minus the current weight, are computed 909. Next, the fit flag is tested 910 to determine if user is trying to gain weight (fit flag=0) or lose weight (fit flag=1).

If the user is trying to lose weight, the value of D1 is tested to determine in the user has lost weight or gained weight 911. If D1 is greater than or equal to zero, the amount of weight loss is set to D1 and the weight to go is set to −D 912. If the amount of weight to go is less than zero, then it is set to zero 913, 914. The amount of weight lost and the amount of weight remaining to lose is then displayed 915. After three seconds a long message “L” is then displayed as described in the flowchart on FIG. 11. If the user is trying to lose weight but has actually gained weight (D1<0) 911, the amount of weight gain is set equal to −D1 and the amount of weight to go is set to D. If the amount of weight to go is less than zero, then it is set to zero 917, 918. The amount of weight gained and the amount of weight remaining to lose is then displayed 919. After three seconds a long message “L” is then displayed as described in the flowchart on FIG. 11.

If the user is trying to gain weight (fit flag=0), the value of D1 is tested to determine in the user has lost weight or gained weight 920. If D1 is greater than or equal to zero, the amount of weight gain is set to −D1 and the weight to add is set to D 921. If the amount of weight to go is less than zero, then it is set to zero 922, 923. The amount of weight gained and the amount of weight remaining to gain is then displayed 924. After three seconds a long message “L” is then displayed as described in the flowchart on FIG. 11. If the user is trying to gain weight but has actually lost weight (D1<0) 920, the amount of weight gain is set equal to D1 and the amount of weight to add is set to −D 925. If the amount of weight to add is less than zero, then it is set to zero 926, 927. The amount of weight lost and the amount of weight remaining to add is then displayed 928. After three seconds a long message “L” is then displayed as described in the flowchart on FIG. 11.

The operation of information display for metric units in FIG. 10 is the same as that described in FIG. 9 for English units.

The flowchart illustrated in FIG. 11 describes the operation of displaying long messages “L”. The first task is to determine which type of long message to display 1101. This is achieved in a random fashion by picking the category based on the current second value of the watch.

If the second setting is in the range of 45-49, then dinner messages are displayed. The dinner message index E1 is incremented 1102 and if it is greater than 100 it is reset to zero 1103, 1104. This is done because there are 100 messages in each category. The long dinner message indexed by E1 is then displayed 1105.

If the second setting is in the range of 25-29, then lunch messages are displayed. The lunch message index E2 is incremented 1106 and if it is greater than 100 it is reset to zero 1107, 1108. The long lunch message indexed by E2 is then displayed 1105.

If the second setting is in the range of 5-9, then breakfast messages are displayed. The breakfast message index E3 is incremented 1109 and if it is greater than 100 it is reset to zero 1110, 1111. The long breakfast message indexed by E3 is then displayed 1105.

If the second setting is in the range of 15-19 or 55-59, then snack messages are displayed. The snack message index E4 is incremented 1112 and if it is greater than 100 it is reset to zero 1113, 1114. The long snack message indexed by E4 is then displayed 1105.

If the second setting is in the range of 0-4, 20-24, 30-34, 40-44, or 50-54, then exercise messages are displayed. The exercise message index E6 is incremented 1118 and if it is greater than 100 it is reset to zero 1119, 1120. The long fit score message indexed by E6 is then displayed 1105.

The display of long messages 1105 can be scrolled at two different rates by pressing the S4 (24) pushbutton. In addition, pressing pushbutton S2 (22) stops the display of a long message. Pressing S2 (22) again continues the scrolling of the long message. One second after the long message display 1105 the watch returns to normal watch functions “W”.

Information button 25 is position in the illustrated embodiment near exercise food button 26. Accordingly, the user may choose to press information button 25 rather than having an extra snack and pressing food button 26 thereby decreasing calories consumed.

Upon pressing information button 25 for a shorter predetermined amount of time, display 31 in the preferred embodiment will display a message. Such message can be of an encouraging nature, a reinforcing nature, a factual nature. In particular, messages appropriate for a user depending on their exercise schedule and eating behavior.

Display 31 may also show short textual messages that change regularly. The messages may be of any appropriate nature and in the preferred embodiment fit within two lines of ten characters each. The messages can be dependent upon the overall visual indication of the success degree, and may also be in comparison to the user exercise or eating behavior over the 24 hour time period.

It will be appreciated that the information input during the setup process can be incorporated in the messages shown in display 31, such as the user's name and weight goals.

The device can also be used as an alarm clock, timer or chronograph, and uses a standard watch battery, or other suitable battery, for power, as many wristwatches and handheld devices on the market, incorporated herein by reference. A wrist strap may be adjustable for standard wrist sizes and the watch may come in different colors and materials.

In the illustrated embodiment, display 12 includes at least three sub-displays: the current time and date, the message display, and the personal goal display. The current time and date display are self-explanatory and display the current time and date as is customary in many displays. The message display has been described in more detail above and may display current smoking frequency statistics or display encouraging, factual, or other messages.

The flowchart illustrated in FIG. 13 describes the operation of displaying short messages “Z” that is part of the normal watch display 29. The first task is to determine which type of short message to display 1301, 1302, 1303, 1305, 1306. Short messages are changed on the watch display 29 every five minutes.

If the minute setting is 0, 20, 30, 40, or 50, then a short exercise message is displayed. To determine which type of exercise message to display, first it is determined whether the current time is before or after the daily scheduled time to begin exercising 1307, 1308. If the current time is prior to the scheduled exercise time, then it is determined whether the user has already started or completed exercising 1309. If the user has already started exercise for the current day (E.P.T.=1) 1309, then short message list containing messages that congratulate the user for exercising 1310 is used along with index F2 1311 to choose a new message. The message index F2 is then incremented 1311 and if it is greater than 100 itis reset to zero 1312, 1313. This is done because there are 100 messages in each category. Control is then returned to the normal display algorithm 1314. If the user has not yet started exercise for the current day (E.P.T.=0) 1309, then short message list containing messages reminding the user to exercise 1315 is used along with index F1 1316 to choose a new message. The message index F1 is then incremented 1316 and if it is greater than 100 it is reset to zero 1317, 1318. Control is then returned to the normal display algorithm 1314.

If the current time is after the scheduled exercise time, then it is determined whether the user has already started or completed exercising 1319. If the user has already started exercise for the current day (E.P.T.=1) 1319, then short message list containing messages that congratulate the user for exercising 1320 is used along with index F4 1321 to choose a new message. The message index F4 is then incremented 1321 and if it is greater than 100 it is reset to zero 1322, 1323. Control is then returned to the normal display algorithm 1314. If the user has not yet started exercise for the current day (E.P.T.=0) 1319, then short message list containing messages reminding the user they are overdue to exercise 1324 is used along with index F3 1325 to choose a new message. The message index F3 is then incremented 1325 and if it is greater than 100 it is reset to zero 1326, 1327. Control is then returned to the normal display algorithm 1314.

If the minute setting is 15 or 55, then a short snack message is displayed. First it is determined how many snacks have been recorded for the current day 1328, 1329, 1330. If no snacks have been recorded, a message encouraging not eating snacks is chosen for display 1331. Although not explicitly illustrated in FIG. 13, the mechanism for choosing snack avoidance messages 1331 is identical to the mechanism for choosing short exercise messages 1310, 1311, 1312, 1313. Control is then returned to the normal display algorithm 1314. If one snack has been recorded, a message encouraging not eating additional snacks is chosen for display 1332. Although not explicitly illustrated in FIG. 13, the mechanism for choosing additional snack avoidance messages 1332 is identical to the mechanism for choosing short exercise messages 1310, 1311, 1312, 1313. Control is then returned to the normal display algorithm 1314. If two or three snacks have been recorded, a strong message alerting over snacking is chosen for display 1333. Although not explicitly illustrated in FIG. 13, the mechanism for choosing over snacking alert messages 1333 is identical to the mechanism for choosing short exercise messages 1310, 1311, 1312, 1313. Control is then returned to the normal display algorithm 1314. If more than three snacks have been recorded, a message indicating that over snacking is a major problem is chosen for display 1334. Although not explicitly illustrated in FIG. 13, the mechanism for choosing major over snacking messages 1334 is identical to the mechanism for choosing short exercise messages 1310, 1311, 1312, 1313. Control is then returned to the normal display algorithm 1314.

If the minute setting is 5, then a short breakfast message is displayed. If the current time is earlier than the scheduled breakfast time and the user has not yet eaten breakfast 1335, then a message encouraging eating a healthy breakfast and avoiding pastries is chosen 1336. Although not explicitly illustrated in FIG. 13, the mechanism for choosing such messages 1336 is identical to the mechanism for choosing short exercise messages 1310, 1311, 1312, 1313. Control is then returned to the normal display algorithm 1314. If the current time is earlier than the scheduled breakfast time and the user has eaten breakfast 1337, then a message highlighting that a healthy breakfast gives you energy is chosen 1338. Although not explicitly illustrated in FIG. 13, the mechanism for choosing such messages 1338 is identical to the mechanism for choosing short exercise messages 1310, 1311, 1312, 1313. Control is then returned to the normal display algorithm 1314. If the current time is later than the scheduled breakfast time and the user has not eaten breakfast 1339, then a message highlighting that a healthy breakfast gives you energy is chosen 1340. Although not explicitly illustrated in FIG. 13, the mechanism for choosing such messages 1340 is identical to the mechanism for choosing short exercise messages 1310, 1311, 1312, 1313. Control is then returned to the normal display algorithm 1314. If the current time is later than the scheduled breakfast time and the user has eaten breakfast 1339, then no message is chosen and control is then returned to the normal display algorithm 1314.

If the minute setting is 25, then a short lunch message is displayed 1341. Although not explicitly illustrated in FIG. 13, the choice of short lunch messages is determined in an identical manner as shown for short breakfast message determination 1335, 1336, 1337, 1338, 1339, 1340.

If the minute setting is 45, then a short dinner message is displayed 1342. Although not explicitly illustrated in FIG. 13, the choice of short lunch messages is determined in an identical manner as shown for short breakfast message determination 1335, 1336, 1337, 1338, 1339, 1340.

If the minute setting is 10 or 35, then the fit score is chosen for display. Control is then returned to the normal display algorithm 1314.

The flowchart illustrated in FIG. 14 describes the operation of pulse counter “P” that is accessed from the normal watch display 29 in FIG. 2 by pressing pushbutton S4 (24). The first display indicates pulse count mode 1401. After three seconds, the maximum heart rate, 85% of maximum heart rate, 70% of maximum heart rate, and the desired pulse count is displayed 1402. When the user is ready and positioned to count their pulse, they press pushbutton S2 (22). At this point the watch begins to beep at one-second intervals and the display counts down from ten to zero while the user counts pulses 1403. After the ten second count down period has ended the maximum, 70%, and 85% pulse count targets corresponding to equivalent heart rates illustrated in display 1402 are displayed. This allows the user to compare the pulse count they just measured with their target goals. From the pulse count target display 1404, the user may repeat a pulse count measurement by pressing pushbutton S2 (22) which returns the watch to display 1403. Note that the watch can be returned to normal watch display “W” anytime during pulse counter mode 1401, 1402, 1403, 1404, and 1405 by pressing pushbutton S3 (23). In addition the other watch modes “L”, “1”, “F”, or “E” described elsewhere can also be accessed by pressing pushbuttons S5 (25) or S6 (26).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

1. A habit modification aide comprising:
a user-modifiable BMI (body mass index) goal, weight goal;
a display for displaying messages dependent upon a daily eating schedule, exercise schedule and the number of times a user-initiated habit-occurrence indicator is used; and
an overall visual indication of the degree to which the user is maintaining the eating and exercise schedule
